(19) United States
(12) Patent Application Publication
(10) Pub. No.: US 2014/0053525 A1
(43) Pub. Date: Feb. 27, 2014

(54) HARVESTING HEAD WITH CROP DEFLECTOR

(71) Applicants: Nicholas Borkgren, Cambridge, IL (US); Daniel Hoffman, East Moline, IL (US); Anthony Washburn, Orion, IL (US)

(72) Inventors: Nicholas Borkgren, Cambridge, IL (US); Daniel Hoffman, East Moline, IL (US); Anthony Washburn, Orion, IL (US)

(21) Appl. No.: 13/591,464

(22) Filed: Aug. 22, 2012

(51) Int. Cl. A01D 57/20

(52) U.S. Cl. CPC A01D 57/20
USPC 56/181

(57) ABSTRACT

A harvesting head (100) has a laterally extending frame (102) on which left and right side conveyor belts (120, 122) are supported. A center conveyor belt (124) is disposed between the left and right side conveyor belts (120, 122) to receive crop material from the left and right side conveyor belt (120, 122) and carry it rearward. Crop deflectors (112, 114) are disposed between the left side conveyor belt (120) and the center conveyor belt (124) and between the right side conveyor belt (122) and the center conveyor belt (124) to deflect cut crop material away from the gaps between the belts and prevent substantially all the cut crop material from being drawn into the gaps between the belts and ejected onto the ground.

### FIELD OF THE INVENTION

This invention relates to harvesting heads. More particularly it relates to deflectors for deflecting cut crop that is carried on endless belt conveyors of the harvesting heads.

### BACKGROUND OF THE INVENTION

Agricultural harvesters are comprised of a self propelled agricultural harvesting vehicle often called a “combine” that supports an agricultural harvesting head also known as a “header”. The header separates the crop from the ground and carries it rearward through an opening in the header. The crop is then sent to the agricultural harvesting vehicle where it is threshed, separated, and cleaned.

In one arrangement the headers have left and right side endless belt conveyors to convey crops laterally inward toward a central region of the header. The outlets of these conveyors face each other and project crop toward each other at the middle of the header. Disposed between the left and right side conveyors is a center conveyor. The center conveyor is disposed slightly below the left and right side conveyors. The center conveyor receives crop falling from the outlets of the left and right side conveyors. The center conveyor conveys the crop rearward (i.e. at right angles to the crop flow direction of the left and right side conveyors.

One problem with this arrangement is that of crop loss. Crop that travels completely across the center of conveyor can become wedged between the side conveyor and the center conveyor on the opposing side of the center conveyor from where the crop enters. Even worse, the crop can pass through the gap between the side conveyor and center conveyor and be deposited on the ground.

By providing a deflector at the outlets of each of the left and right side conveyors, a substantial portion of this cut crop material can be prevented from being pulled underneath the left and right side conveyors and deposited on the ground.

### SUMMARY OF THE INVENTION

In accordance with one aspect of the invention, a harvesting head is provided having
a laterally extending frame,
a left side conveyor belt supported by the laterally extending frame, the left side conveyor belt having an upper surface and a crop outlet, the upper surface being configured to convey crops in a first direction, the left side conveyor belt being supported at its innermost extent on a first inner conveyor roller,
a right side conveyor belt supported by the laterally extending frame, the right side conveyor belt having an upper surface and a crop outlet, the upper surface being configured to convey crops in a second direction, the right side conveyor belt being supported at its innermost extent on a second inner conveyor roller,
wherein the first direction and the second direction are diametrically opposed, and
a center conveyor belt disposed between and slightly below the outlets of the left and right side conveyors, the center conveyor belt having an upper surface configured to convey crops in a third direction normal to both the first direction and the second direction end,
a first crop deflector extending across substantially the entire width of the left side conveyor belt, the first crop deflector having a leading edge that extends across substantially the entire width of the left side conveyor belt and parallel with the rotational axis of the inner roller of the left side conveyor and at at least the same height as the rotational axis of the inner roller of the left side conveyor, and a trailing edge opposite the leading edge that extends across substantially the entire width of the left side conveyor belt and is generally parallel to and spaced slightly apart from the upper surface of the center conveyor belt,
a second crop deflector extending across substantially the entire width of the right side conveyor belt, the second crop deflector having a leading edge that extends across substantially the entire width of the right side conveyor belt and parallel with the rotational axis of the inner roller of the right side conveyor and at at least the same height as the rotational axis of the inner roller of the right side conveyor, and a trailing edge opposite the leading edge of the second crop deflector, wherein the trailing edge of the second crop deflector extends across substantially the entire width of the right side conveyor belt and is generally parallel to and spaced slightly apart from the upper surface of the center conveyor belt.

The left side conveyor belt, the right side conveyor belt and the center conveyor belt made each be an endless loop of elastomer-coated fabric and may be configured to convey a mat of fibrous plant stalks and loose seed.

A first gap may be provided between the leading edge of the first crop deflector and the left side conveyor belt that extends substantially the entire width of the left side conveyor belt and is below the top surface of the left side conveyor belt and is narrow enough to prevent substantially all the cut crop material exiting the left side conveyor belt from entering the first gap.

A second gap may be provided between the leading edge of the second crop deflector and the right side conveyor belt that extends substantially the entire width of the right side conveyor belt and is below the top surface of the right side conveyor belt and is narrow enough to prevent substantially all the cut crop material exiting the right side conveyor belt from entering the second gap.

A third gap may be provided between the trailing edge of the first crop deflector and the center conveyor belt that extends substantially the entire length of the center conveyor belt and is below the leading edge and is narrow enough to prevent substantially all the cut crop material exiting the right side conveyor belt from entering the third gap.

A fourth gap may be provided between the trailing edge of the second crop deflector and the center conveyor belt that extends substantially the entire length of the center conveyor belt and is below the leading edge and is narrow enough to prevent substantially all the cut crop material exiting the left side conveyor belt from entering the fourth gap.

In accordance with another aspect of the invention, a harvesting head crop deflector is provided, the harvesting head having a laterally extending frame, a left side conveyor belt supported by the laterally extending frame on the left side of the laterally extending frame, the left side conveyor belt having an upper surface and a crop outlet, the upper surface being configured to convey cut crop material in a first direction, the left side conveyor belt being supported at its innermost extent on a first inner conveyor roller, a right side conveyor belt supported by the laterally extending frame on the right side of the laterally extending frame, located opposite to and spaced apart from the left side conveyor belt, the right side conveyor belt having an upper surface and a crop outlet, the upper surface being configured to convey cut crop material in a second direction, the right side conveyor belt being supported at its innermost extent on a second inner conveyor roller, wherein the first direction and the second direction are diametrically opposed, a center conveyor belt disposed between and below the outlets of the left and right side conveyors, the center conveyor belt having an upper surface configured to convey crops in a third direction normal to both the first direction and the second direction,

wherein the crop deflector is an elongate member that extends across substantially the entire width of either the left side conveyor belt or the right side conveyor belt, wherein the crop deflector has a leading edge configured to extend across substantially the entire width of said either the left side conveyor belt or the right side conveyor belt, wherein the crop deflector extends parallel with the rotational axis of either the first inner conveyor roller or the second inner conveyor roller and at at least the same height as the rotational axis of either the first inner conveyor roller or the second inner conveyor roller, the crop deflector further having a trailing edge opposite the leading edge, wherein said trailing edge is configured to extend across substantially the entire width of the left side conveyor belt or the right side conveyor belt and wherein said trailing edge is configured to be disposed generally parallel to and spaced slightly apart from the upper surface of the center conveyor belt.

The crop deflector may be configured to be mounted on the harvesting head such that the leading edge of the crop deflector extends substantially the entire width of either the left side conveyor belt or the right side conveyor belt and is below the top surface of said either the left side conveyor belt or the right side conveyor belt to create a first gap therebetween that is narrow enough to prevent substantially all the cut crop material exiting the said either the left side conveyor belt or the right side conveyor belt from entering the first gap.

### BRIEF DESCRIPTION OF THE DRAWINGS

FIG. 1 is a perspective view of a harvesting head in accordance with the present invention.

FIG. 2 is a close-up fragmentary plan view of the center of the harvesting head of FIG. 1.

FIG. 3 is a close-up fragmentary front view of the center of the harvesting head of FIGS. 1-2 taken at section line 3-3 in FIG. 2.

### DETAILED DESCRIPTION

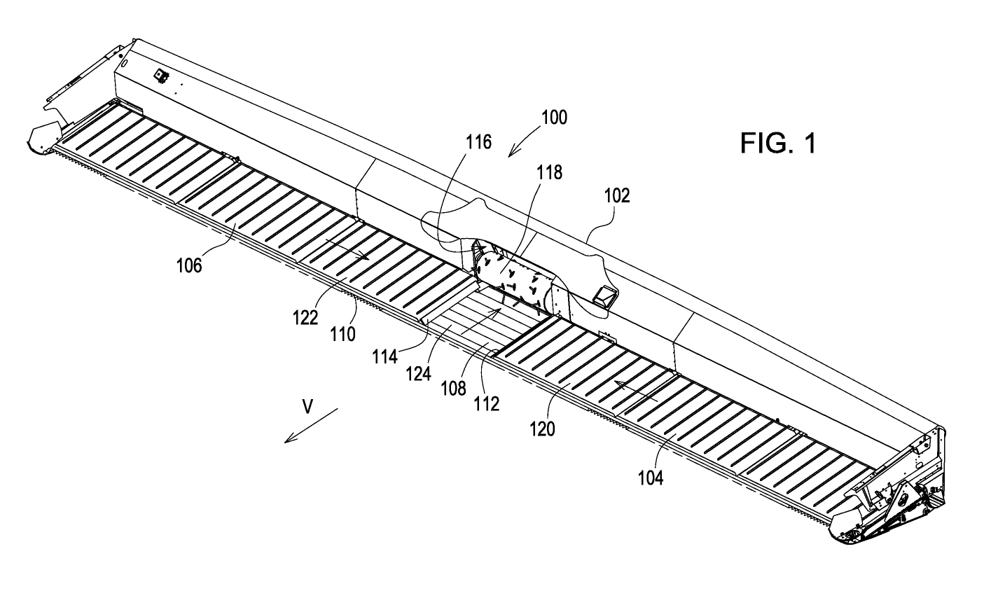

In FIG. 1, a harvesting head 100 includes a laterally extending frame 102 that extends substantially the entire width of the harvesting head, a left side conveyor 104, a right side conveyor 106, a center conveyor 108, a reciprocating knife 110, a first crop deflector 112, a second crop deflector 114, and a feed roll 118.

Frame 102 as a central opening 116 disposed at the middle of harvesting head 100 and in which feed roll 118 is mounted.

Left side conveyor 104 includes a left side conveyor belt 120 which is supported on rollers, and has an upper surface which conveys crop material to the right (indicated by the arrow) toward center conveyor 108.

Right side conveyor 106 includes a right side conveyor belt 122 which has an upper surface that conveys the crop material to the left (indicated by the arrow) toward center conveyor 108.

Center conveyor 108 includes a center conveyor belt 124 which has an upper surface that conveys the crop material to the rear (indicated by the arrow) toward central opening 116.

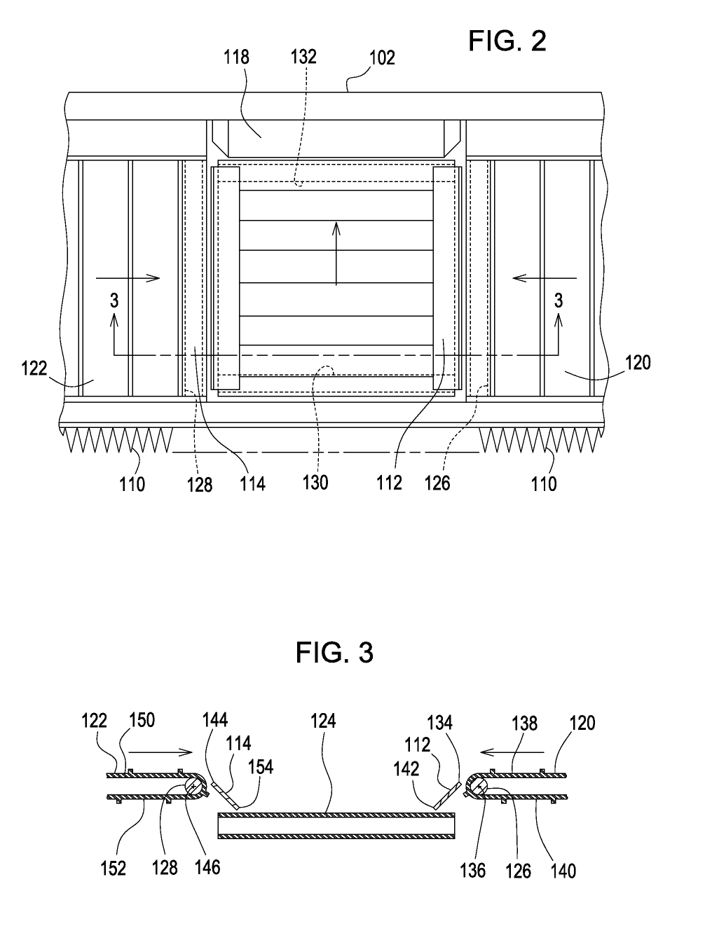

Referring to FIGS. 2-3, left side conveyor belt 120 is supported on an inner roller 126. A similar outer roller (not shown) supports the outermost end of left side conveyor belt 120.

Right side conveyor belt 122 is supported on an inner roller 128. A similar outer roller (not shown) supports the outermost end of right side conveyor belt 122.

Center conveyor belt 124 is supported on a forward roller 130, and a rear roller 132. Forward roller 130 is disposed adjacent to the forward edges of left side conveyor belt 120 and right side conveyor belt 122. Rear roller 132 is disposed adjacent to the rear edges of left side conveyor belt 120 and right side conveyor belt 122. The center conveyor belt 124 has an upper surface that extends across substantially the entire fore-and-aft extent of the left side conveyor belt 120 and the right side conveyor belt 122.

The left side conveyor belt 120, the right side conveyor belt 122, and the center conveyor belt 124, are formed as endless loops made of an elastomeric coated fabric.

The first crop deflector 112 is an elongate member having a longitudinal extent and a leading edge 134 that extend generally fore-and-aft. Leading edge 134 is generally parallel to the rotational axis 136 of the inner roller 126 that supports left side conveyor belt 120. It is at the same height as the rotational axis 136, and thus is disposed at the innermost extent of left side conveyor belt 120. It is disposed vertically about halfway between the upper run 138 of the left side conveyor belt 120 and the lower (i.e. return) run 140 of the left side conveyor belt 120. This vertical position permits crop that is propelled off the top surface of the left side conveyor belt 120 onto the center conveyor belt 124 to fall downward on to the top surface of first crop deflector 112, or (depending upon the speed of the left side conveyor belt 120) to be propelled completely across the top surface of first crop deflector 112 and onto the top surface of the center conveyor belt 124.

The leading edge 134 is spaced away from the left side conveyor belt 120 to create a gap that extends substantially the entire width of the left side conveyor belt 120. This gap is disposed below the top surface of the left side conveyor belt 120. The gap is narrow enough to prevent substantially all the cut crop material exiting the left side conveyor belt 120 from entering the gap. The gap is wide enough to prevent the upper surface of left side conveyor belt 120 from rubbing against and being damaged by the leading edge 134.

The location of the leading edge 134 of first crop deflector 112 makes it difficult for cut crop material to wrap around the inner roller 126 and be pulled into the gap between the lower run 140 of the left side conveyor belt 120 and the center conveyor belt 124. Cut crop material that gets into this gap between the two conveyor belts is pulled downward and ejected onto the ground underneath the header.

The first crop deflector 112 has a trailing edge 142 that extends generally parallel to the leading edge 134. The trailing edge 142 is disposed a slight distance from the upper surface of center conveyor belt 124 over substantially its entire length to create a gap therebetween. This gap is large enough to prevent the upper surface of center conveyor belt 124 from rubbing against and being damaged by the trailing edge 142, and is small enough to prevent cut crop material ejected by the right side conveyor belt 122 from being jammed into the gap by right side conveyor belt 122, then being pulled by the lower run of left side conveyor belt 120 into the gap between the lower run of left side conveyor belt 120 and the upper surface of center conveyor belt 124. In this manner, crop material projected by the right side conveyor belt 122 is retained and not lost.

The upper surface of the first crop deflector 112 extends between the leading edge 134 and the trailing edge 142 of the first crop deflector 112. The upper surface is disposed at an angle as best shown in FIG. 3, such that a traversal of the upper surface of the first crop deflector 112 from the leading edge 134 to the trailing edge 142 includes a drop in height.

The second crop deflector 114 is an elongate member having a longitudinal extent and a leading edge 144 that extend generally fore-and-aft. Leading edge 144 is generally parallel to the rotational axis 146 of the inner roller 128 that supports right side conveyor belt 122. It is at the same height as the rotational axis 146, and thus is disposed at the innermost extent of right side conveyor belt 122. It is disposed vertically about halfway between the upper run 150 of the right side conveyor belt 122 and the lower (i.e. return) run 152 of the right side conveyor belt 122. This vertical position permits crop that is propelled off the top surface of the right side conveyor belt 122 onto the center conveyor belt 124 to fall downward onto the top surface of second crop deflector 114, or (depending upon the speed of the left side conveyor belt 120) to be propelled completely across the top surface of second crop deflector 114 and onto the top surface of the center conveyor belt 124.

The leading edge 144 is spaced away from the right side conveyor belt 122 to create a gap that extends substantially the entire width of the right side conveyor belt 122. This gap is disposed below the top surface of the right side conveyor belt 122. The gap is narrow enough to prevent substantially all the cut crop material exiting the right side conveyor belt 122 from entering the gap. The gap is wide enough to prevent the upper surface of right side conveyor belt 122 from rubbing against and being damaged by the leading edge 144.

The location of the leading edge 144 of second crop deflector 114 makes it difficult for cut crop material to wrap around the inner roller 128 and be pulled into the gap between the lower run 152 of the right side conveyor belt 122 and the center conveyor belt 124. Cut crop material that gets into this gap between the two conveyor belts may be pulled downward and ejected onto the ground underneath the header.

The second crop deflector 114 has a trailing edge 154 that extends generally parallel to the leading edge 144. The trailing edge 142 is disposed a slight distance from the upper surface of center conveyor belt 124 over substantially its entire length to create a gap therebetween. This gap is large enough to prevent the upper surface of center conveyor belt 124 from rubbing against and being damaged by the trailing edge 142, and is small enough to prevent cut crop material ejected by the right side conveyor belt 122 from being jammed into the gap by right side conveyor belt 122, then being pulled by the lower run of left side conveyor belt 120 into the gap between the lower run of left side conveyor belt 120 and the upper surface of center conveyor belt 124. In this manner, crop material projected by the right side conveyor belt 122 is retained and not lost.

The upper surface of the second crop deflector 114 extends between the leading edge 144 and the trailing edge 154 of the second crop deflector 114. The upper surface is disposed at an angle as best shown in FIG. 3, such that the leading edge 144 is above the trailing edge 154.

The above described embodiments are not limited to the concept of the invention, but describe only the currently preferred embodiments. Within the scope of the invention, many other variants can be envisaged. For example, the deflectors may be disposed at the angle shown herein, or they may be more horizontal or more vertical. The leading edge of the deflectors may be disposed at the level shown herein, or it may be disposed higher or lower. The trailing edge of the deflectors may be disposed at the level shown herein, or it may be disposed higher, or lower. The deflectors may be curved to provide a convex or a concave upper surface. The deflectors may be creased or bent. The deflectors may be fixed to any stationary structure adjacent to the deflectors. The particular structure or structures to which they are fixed forms no part of the present invention. As long as they are held in position to perform the functions described herein, it is sufficient.

1. A harvesting head (100) comprising:
a laterally extending frame (102),
a left side conveyor belt (120) supported on a left side of the laterally extending frame (102), the left side conveyor belt (120) having an upper surface and a crop outlet, the upper surface being configured to convey cut crop material in a first direction, the left side conveyor belt (120) being supported at its innermost extent on a first inner conveyor roller (126) having a rotational axis (136);
a right side conveyor belt (122) supported on a right side of the laterally extending frame (102) and located opposite to and spaced apart from the left side conveyor belt (120), the right side conveyor belt (122) having an upper surface and a crop outlet, the upper surface being configured to convey cut crop material in a second direction, the right side conveyor belt (122) being supported at its innermost extent on a second inner conveyor roller (128) having a rotational axis (146), wherein the first direction and the second direction are directionally opposed;
a center conveyor belt (124) disposed between and below the outlets of the left and right side conveyor belts (120, 122), the center conveyor belt (124) having an upper surface configured to convey crop material in a third direction normal to both the first direction and the second direction; and
a first crop deflector (112) extending across substantially the entire width of the left side conveyor belt (120), the first crop deflector (112) having a continuous straight upper edge (134) that extends across substantially the entire width of the left side conveyor belt (120) and is parallel with and at a height at least as high as the rotational axis of the first inner conveyor roller (126) and being spaced slightly apart from an inner extent of the left side conveyor belt (120) so as to define a first gap narrow enough to prevent substantially all the cut crop material exiting the left side conveyor belt (120) from entering the first gap, and a lower edge (142) that extends across substantially the entire width of the left side conveyor belt (120) and is generally parallel to and spaced slightly apart from the upper surface of the center conveyor belt (124) so as to define a second gap narrow enough to prevent substantially all the cut crop material exiting the right side conveyor belt (122) from entering the second gap;
a second crop deflector (114) extending across substantially the entire width of the right side conveyor belt (122) and having a continuous straight upper edge (144) that extends across substantially the entire width of the right side conveyor belt (122) and is parallel with and at a height at least as high as the rotational axis (146) of the second inner conveyor roller (128) and is spaced slightly apart from an inner extent of the right side conveyor belt (122) so as to define a third gap narrow enough to prevent substantially all the cut crop material exiting the right side conveyor belt (122) from entering the third gap, and a lower edge (154) of the second crop deflector (114) extends across substantially the entire width of the right side conveyor belt (122) and is generally parallel to and spaced slightly apart from the upper surface of the center conveyor belt (124) so as to define a fourth gap narrow enough to prevent substantially all the cut crop material exiting the left side conveyor belt (120) from entering the fourth gap.

2. The harvesting head (100) of claim 1, wherein the left side conveyor belt (120), the right side conveyor belt (122) and the center conveyor belt (124) are each an endless loop of elastomer-coated fabric and are configured to convey a mat of fibrous plant stalks and loose seed.

3. (canceled)

4. (canceled)

5. (canceled)

6. (canceled)

7. In a harvesting head (100) including a crop deflector wherein, the harvesting head (100) has a laterally extending frame (102), a left side conveyor belt (120) supported by the laterally extending frame (102) on the left side of the laterally extending frame (102), the left side conveyor belt (120) having an upper surface and a crop outlet, the upper surface being configured to convey cut crop material in a first direction, the left side conveyor belt (120) being supported at its innermost extent on a first inner conveyor roller (126), a right side conveyor belt (122) supported on the right side of the laterally extending frame (102) and located opposite to and being spaced apart from the left side conveyor belt (120), the right side conveyor belt (122) having an upper surface and a crop outlet, the upper surface being configured to convey cut crop material in a second direction, the right side conveyor belt (122) being supported at its innermost extent on a second inner conveyor roller (128), wherein the first direction and the second direction are directionally opposed, a center conveyor belt (124) disposed between and below the outlets of the left and right side conveyors, the center conveyor belt (124) having an upper surface configured to convey crops in a third direction normal to both the first direction and the second direction, the crop deflector (112, 114), comprising:
an elongate member is substantially rectangular and fixed in a position extending across substantially the entire width of one of the left side conveyor belt (120) or the right side conveyor belt (122), wherein the crop deflector (112, 114) has an upper edge (134, 144) extending across substantially the entire width of said one of the left side conveyor belt (120) or the right side conveyor belt (122), wherein the upper edge (134, 144) of the crop deflector (112, 114) extends parallel with and at a height at least as high as the rotational axis (136, 146) of said one of the first inner conveyor roller (126) or the second inner conveyor roller (128) and is spaced slightly apart from an innermost extent of said one of the left side conveyor belt (120) or the right side conveyor belt (122) so as to define a first gap; and the crop deflector (112, 114) further having a lower edge (142, 154) extending across substantially the entire width of said one of the left side conveyor belt (120) or the right side conveyor belt (122) and extending generally parallel to and spaced slightly apart from the upper surface of the center conveyor belt (124) so as to define a second gap.

8. The harvesting head (100) of claim 7, wherein the crop deflector (112, 114) is mounted on the harvesting head (100) such that it extends downwardly and inwardly from the upper edge (134, 144) to the lower edge (142, 154) of the crop deflector (112, 114) and the upper edge (134, 144) is below the top surface of said one of the left side conveyor belt (120) or the right side conveyor belt (122) to create the first gap therebetween, with the first gap being narrow enough to prevent substantially all the cut crop material exiting the said one of the left side conveyor belt (120) or the right side conveyor belt (122) from entering the first gap, and with the second gap likewise being narrow enough to prevent substantially all the cut crop material exiting that one of the left side conveyor belt (120) or the right side conveyor belt (122) which is most remote from the second gap.
